(19) United States
(12) Patent Application Publication
(10) Pub. No.: US 2002/0027316 A1
(43) Pub. Date: Mar. 7, 2002

(54) Asbestos-free product sintered from building material wastes containing asbestos and method of producing the same

(76) Inventors: Takashi Ishikawa, Higashine-shi (JP); Ryuichi Takahashi, Yamagata-shi (JP)

Correspondence Address: KANESAKA AND TAKEUCHI, 1423 Powhatan Street, Alexandria, VA, 22314, US

(21) Appl. No.: 09/878,317

(22) Filed: Jun. 12, 2001

(30) Foreign Application Priority Data
Jun. 14, 2000 (JP) 2000-178059
Nov. 27, 2000 (JP) 2000-360210
Dec. 6, 2000 (JP) 2000-371389
Mar. 29, 2001 (JP) 2001-095167
Mar. 29, 2001 (JP) 2001-095168

(51) Int. Cl. C04B 33/32; C04B 35/64

(52) U.S. Cl. 264/669; 264/681; 501/155

(57) ABSTRACT

Building material wastes containing harmful asbestos and inorganic wastes are subjected to sintering reaction treatment to obtain asbestos-free products which are provided for recycling of waste materials. The asbestos containing building materials inorganic wastes are crushed to be mixed such that the mixture is subjected to a sintering step at a temperature of 600° C. through 1500° C. to allow the same to react thereto, thus obtaining sintered reaction products which is asbestos-free and non-hazardous. The inorganic wastes includes incineration ash from sewerage sludge which has so far used for reclamation purpose only. Sherd, glass wastes or the like can also mixed therewith for sintering reaction to obtain non-hazardous permeable blocks, thus contribution to establishing recycling systems. The method of producing such asbestos-free non-hazardous products are also provided.

### BACKGROUND OF THE INVENTION

The present invention relates to an asbestos-free reusable product obtained from building material wastes containing hazardous asbestos by subjecting said building material wastes to a sintering step to allow the same to react with inorganic wastes which have so far been used for reclamation work alone and to a method of manufacturing such asbestos-free reusable product.

Building materials containing hazardous asbestos as represented by chrysotile has been in wide use as materials for roofs or walls of buildings for a dwelling or non-dwelling purpose for more than thirty years.

Although building materials containing less asbestos therein are nowadays being put on the market, it is not that the asbestos content therein is nil. On the contrary, the building materials of high asbestos content in the past remain in use in buildings, posing a problem of asbestos which inevitably accompanies dilapidation of such buildings. Particularly, an effective method of treating such wastes has not been completed.

For example, it has been proposed as a means of treating the wastes of building materials containing asbestos that asbestos is buried in the earth in the form of large masses or that asbestos is molten in a kiln at a temperature of 1500° C. or more and is allowed to stand until it is set such that the resultant masses are buried at a stable type final disposal site.

On the other hand, inorganic wastes including incineration ash of sewage sludge or general waste from incineration systems, waste materials from public engineering works, ceramic works or the like are almost invariably used for reclamation purposes. Only a small portion of them is crushed into particles of a suitable size to be used for the manufacture of aggregates or concrete blocks or the like and there has been proposed no effective ways of recycling the rest which is not reused.

As a prior art composition in which the art of heat treatment of industrial wastes such as asbestos cement is disclosed in Japanese Patent Appln. (Kokai) Pub. No. 5-293457, in which the asbestos contained in the asbestos cement is dehydrated to destroy the crystalline structure thereof to transform the same into a substance other than asbestos. Further, the heat treatment decomposes the binder in the asbestos cement into a hydraulic substance. However, the publication discloses merely the treatment of asbestos cement per se and there is no mention of treatment of building materials containing asbestos.

Japanese Patent Appln. (Kokai) Pub. No. 9-206726 discloses that industrial wastes containing asbestos and incineration ashes from urban refuse were sintered to make the asbestos contained therein non-hazardous. In the publication, it is not clear how industrial wastes and incineration ashes are mixed.

Under the circumstances, building materials containing hazardous asbestos are left as they are since there is no effective method of treating the building materials containing hazardous asbestos while most of the inorganic wastes are subjected to treatments for reclamation use alone.

### SUMMARY OF THE INVENTION

In order to solve the above mentioned problem, the object of the present invention is to provide a reusable product by mixing building material waste containing hazardous asbestos with inorganic waste and subjecting said building material wastes to a sintering step to allow the same to react with said inorganic wastes.

### PREFERRED EMBODIMENTS OF THE PRESENT INVENTION

Many of the asbestos which are used as building materials include serpentine chrysotile (3MgO.2.SiO2H₂O), which it is widely known dehydrates and transforms at a temperature of 600° C. to form harmless forsterite (2MgO.SiO₂) at a temperature of 900° C.

The typical building material containing asbestos is composed of a substrate and a decorative laminate, said substrate being further composed of cement, micro quartz sand, reduced scraps or the like in addition to asbestos. One surface of said substrate is coated with either of glaze, inorganic paints, organic paints.

The inorganic wastes used in the present invention include incineration ash from sewerage sludge, general wastes, ceramic wastes or the like. The principal ingredients of the incineration ash from the sewerage sludge include Si, Al, Fe, Ca, P, Mg, Na, and K while those of the incineration ash from the general wastes include Si, Al, Ca, Mg, Na, K. Further, the principal ingredients of the incineration ash from the ceramic wastes includes Si, Na, K, Al, (Ca). In this way, many substances such as P, Ca, Na, K which easily transform into the glass phase are contained in those wastes such that reaction and sintering simultaneously proceeds at relatively low temperature.

The wastes of building materials containing asbestos and those of inorganic wastes are crushed as necessary to be pulverized and mixed. As a means of crushing, the roll crusher, impellor breaker, roller mill or edge runner mill are used. Needless to say, crushing may be done simultaneously or separately. Otherwise, said wastes of building materials and inorganic waste may be crushed with other materials. The way of crushing in wide application includes the dry or wet method using a crusher such as the tube mill or the ball mill.

The proportion of mixture is within the range of 100 parts by weight of building materials containing asbestos and 5 to 500 parts by weight of inorganic wastes. Such wide range of proportions is due to the need to select a suitable proportion in accordance with the ingredients of the respective waste materials and the proposed use of the regenerated inorganic wastes.

In the mixing step, attention must be paid to ingredients contained in the respective waste materials, particularly, impurities such as iron, alkali earth or the like. For example, the incineration ash from sewerage sludge used as inorganic wastes contains more phosphor or iron than the incineration ash from the general wastes; and the more iron is contained, the worse the capability of the inorganic materials to maintain the shape is after the inorganic wastes have been sintered or the more likely for foams to be formed. On the other hand, more alkali earth ingredients will cause the sintering step to be accelerated. Therefore, in case where the wastes referred to so far are to be sintered as done in the present invention, it is essential to consider an appropriate ratio of ingredients in the mixture by measuring in advance the amounts of the ingredients to be contained.

In mixing the wastes, it is acceptable, for example, to add a viscosity improver for facilitating the mixing steps, or to add mica such that the capability to maintain the shape after the sintering is improved.

After the mixing, the sintering is done at a temperature of 600 to 1500° C., when primary processed materials of particulate shape may be formed by means of a spray drier and a final product may be sintered while passing through an extruder or a press Some of such primary processed materials may be utilized in combination with concrete aggregates or glass wastes td form permeable blocks.

The method of decorating the sintered goods includes adding a glaze at the time of the sintering or adding a glaze after the sintering but it may also be left unglazed.

Hereinafter, embodiments of the present invention will be explained but the invention will not be limited thereto.

### EXAMPLE 1

The ratio of ingredients in the substrate in which an asbestos slate roof material is used as wastes of the building material containing asbestos is as shown in Table 1. As inorganic wastes, the incineration ash from the sewerage sludge having the ratio of ingredients shown in TABLE 2 is used. The ratio of mixture is 100 parts by weight of asbestos slate plate and 80 parts by weight of incineration ash from the sewerage sludge, which are crushed and pulverized together. To 100 parts by weight of said crushed and pulverized mixture, 5 parts by weight of bentonite are added as a viscosity improver. Further, water is added as necessary and the mixture is stirred. After being dried, the mixture is subjected to the sintering reaction at a temperature of 1150° C. for 15 minutes. It is confirmed by an X ray diffraction that the resulting reaction product from the sintering step shows no asbestos peak.

TABLE 1

| | Part by |
|---|---|
| Substrate of Asbestos Slate Roof Material | Weight |
| Asbestos | 20 |
| Cement | 39 |
| Micro Quartz Sand | 26 |
| Reduce Scrap | 15 |
| TOTAL | 100 |

TABLE 2

| Chemical Composition of Incineration | Parts by |
|---|---|
| Ash from Sewerage Sludge | Weight |
| SiO₂ | 40 |
| Al₂O₃ | 17 |
| Fe₂O₃ | 10 |
| CaO | 7 |
| MgO | 3 |
| Na₂O | 1 |
| K₂O | 2 |
| P₂O₅ | 15 |
| Rest | 5 |
| TOTAL | 100 |

### EXAMPLE 2

As building material wastes containing asbestos, the asbestos slate roof material similar to that shown in Example 1 was used. As an inorganic waste, glass waste containing 70% of silica is used. The ratio of mixture is 100 parts by weight of asbestos slate and 35 parts by weight of glass wastes which are to be crushed and pulverized together. To 135 parts by weight of the thus pulverized mixture, 100 parts by weight of crushed stone wastes were added as an aggregate while 30 parts by weight of a sodium silicate were added as a primary binder such that the admixture was blended and pressed in a block mold. Next, carbon dioxide gas is introduced until set and removed from the mold. The block molding removed from the mold is subjected to a sintering step for 15 minutes at a temperature of 1100° C. to obtain a permeable sintered block product. Said permeable sintered block product turned out to have a sufficient strength to be used as a pavement material. Then, it was confirmed by an X-ray analysis that the thus obtained sintered product shows no asbestos peak. From the above examples, it is found out that the present invention has effects in that wastes containing asbestos harmful to human health are made asbestos-free. Moreover, by mixing, causing to react with and sintering together with inorganic wastes such as incineration ash from sewerage sludge, civil engineering waste, ceramic material wastes so far used for reclamation purpose alone, said asbestos-free product has a wider application in recycling.

Next, another embodiment of the invention will be explained hereinafter.

The building material containing asbestos as a fusion binder in the present invention includes a hardened cement material mixed with asbestos and a hardened material such as calcium silicate mixed with asbestos, for example, flat colored slates, wave formed slates, asbestos calcium silicate plates, slag gypsum boards, ceramic sidings, etc. While said materials are enumerated on the basis of the assumption that roof or wall material wastes containing asbestos invariably produced as a result of replacement work or reconstruction are used, those which might otherwise be discarded without being used may be used.

Inorganic building materials containing asbestos which accompanies the replacement work or reconstruction work can easily scatter to fly in all directions because of the aging and deterioration of building materials in which asbestos are used. Therefore, utmost care is needed in the recovery, transport and storage of such inorganic building materials.

Said building materials are subjected to sintering to allow the same to react preferably at a temperature of 600° C. or more. This is because it is confirmed by an X-ray diffraction that no asbestos peak is observed if the sintering step is conducted at a temperature of 600° C. or more. Needless to say, the sintering temperature is decided in view of the fuel expenses, the operating efficiency, and the size and the kind of the facilities involved within the said temperature range. Among various sintering methods, a method in which the piled-up building materials wastes are subjected to sintering in a tunnel kiln without being crushed or another method in which the wastes are brought into a roller kiln in series to be sintered. In view of the cost to be incurred, however, the wastes may be crushed into a size to some degree.

The time required for sintering is not limited to a particular length. All needed is that the asbestos contained in building material wastes are rendered non-hazardous at the above mentioned temperature; that is, the there is no asbestos peak observed by an X-ray analysis. If this condition is met, such time is decided on the basis of the size of the building material wastes and the ways in which the building material wastes are piled up.

The primary ingredients contained in an incineration ash from the sewerage sludge to be used as a fusion binder include Si, Al, Fe, Ca, P, Mg, Na, K among which P, Ca, Na and K which can easily forms a glass phase are contained in abundance such that the sintering reaction proceeds simultaneously at a relatively low temperature.

A binder for molding used in the present invention includes one or combination of clay, bentonite, organic pastes or the like, which easily helps a primary molding by means of a press or the like. Further, sodium silicate may be used where carbon dioxide is blown to harden the sodium silicate.

The aggregate used in the present invention is a highly fire resistant inorganic material including one or combination of sherd, type wastes, pottery wastes, building stone fragments, silica sand, fly ash, chamotte, mica, slag or the like Further, if more building material wastes which act as a fusion binder containing asbestos are mixed in the manufacture of non-hazardous sintered products, a higher sintering temperature is needed such that the fuel expenses invariably increases. However, a lower sintering temperature is possible by adding a fusing agent.

The fusing agent to be used in the present invention includes one of frit, glaze sludge, glass wastes or a combination thereof.

TABLE 3 shows test data concerning the ratio of mixture of the non-hazardous sintered product and a fusing agent such as Ferro's “MX-3P” together with the physical properties of the respective ingredients. The sintering was done at a temperature of 1050° C. In order to fuse the aggregate to stick firmly to each other, it is necessary for the binder to be softened and fused at a sintering temperature range, where it is assumed that the rate of shrinkage, the bulk specific gravity and the bending strength are at maximum levels thereof while the water absorption percentage is nil. If the softening and fusion process further proceeds, the binder has excessive foams therewithin to accelerate the expansion and transformation thereof.

TABLE 3

| | | | |
|---|---|---|---|
| Ratio of Mixture (Weight %) | Non-hazardous | 90 | 60 |
| | asbestos-free | | |
| | sintering product | | |
| | MX-3P | 10 | 40 |
| Rate of Shrinkage (%) | | 1.83 | 12.13 |
| Bulk Specific Gravity | | 1.64 | 2.26 |
| Water Absorption Percentage (%) | | 27.04 | 0.07 |
| Bending Strength (N/cm²) | | 1200 | 5420 |

In TABLE 3, it is shown that if more fusing agent is used for the non-hazardous products, the softening and fusion further proceeds.

As a method of decorating the permeable blocks, some method includes sintering with a glaze or pigments at the time of mixture and/or further sintering with a glaze added thereafter.

Hereinafter, an explanation will be given by showing another example but the invention is not limited thereto.

### EXAMPLE 3

TABLE 4 shows the ratio of ingredients in the substrate of the so-called asbestos slate roof material which is building material wastes containing asbestos. Said building material waste was maintained to stand at a temperature of 1000° C. for 15 minutes and thereafter said wastes are passed through a punching metal plate with a punched hole having a diameter of 2 mm is passed therethrough. In this connection, it was confirmed by an X ray diffraction that this sintered product shows no asbestos peak The ratio of incineration ash of the used sewerage sludge is shown in TABLE 5, where Ferro's “MX-3P” is used as a fusing agent while clay (dried product passable through 80 mesh) is used as a molding binder and sherd (7 to 20 mesh) is used for an aggregate. The mixture is in the mixing ratio as shown in TABLE 6 where an appropriate amount of water is added for kneading and forming the same into particle form before formed into a plate (50 g/piece) by a hand press to be sintered at a temperature of 1050° C. for in an electric kiln. The physical properties of the obtained plate material are as shown in TABLE 7 which shows that the product is an excellent permeable block.

TABLE 4

| Material for Asbestos Slate Roof | |
|---|---|
| Material | Part by Weight |
| Asbestos | 20 |
| Cement | 39 |
| Micro Silica Sand | 26 |
| Reduced Scrap | 15 |
| TOTAL | 100 |

TABLE 5

| Chemical Composition of Incineration | |
|---|---|
| Ash from Sewerage Sludge | Part by Weight |
| SiO₂ | 40 |
| Al₂O₃ | 17 |
| Fe₂O₃ | 10 |
| CaO | 7 |
| MgO | 3 |
| Na₂O | 1 |
| K₂O | 2 |
| P₂O₅ | 15 |
| Rest | 5 |
| Total | 100 |

TABLE 6

| | Ratio of Mixture (Weight %) |
|---|---|
| Asbestos-free Sintered Product | 12.6 |
| Incineration Ash from Sewage | 21.0 |
| Sludge | |
| MX-3P | 8.4 |
| Clay | 6.0 |
| Sherd | 6.0 |

TABLE 7

| Test Item | Measured Value | Performance |
|---|---|---|
| Shrinkage (%) | 2.43 | Good |
| Bulk Specific Gravity | 1.54 | Good |
| Permeation Time | 4.9 | Good |
| Bending Strength | 560 | Good |

Thus, in this embodiment, it is possible to obtain a product in which asbestos wastes hazardous to human health is not only made non-hazardous but sherd or glass wastes can also mixed therewith for sintering reaction such that a non-hazardous permeable block can be offered.

Further, the invention also provides an asbestos-free porous ceramics by mixing building material wastes containing asbestos, incineration ashes from sewerage sludge and aggregates and sintering the mixture. For this purpose a further embodiment will be explained hereinafter.

Similar to one of the previous embodiments, the building material containing asbestos as a fusion binder in the present invention includes a hardened cement material mixed with asbestos and a hardened material such as calcium silicate mixed with asbestos, for example, flat colored slates, wave formed slates, asbestos calcium silicate plates, slag gypsum boards, extrusion cement plates, ceramic sidings, etc. While said materials are enumerated on the basis of the assumption that roof or wall material wastes containing asbestos invariably produced as a result of replacement work or reconstruction are used, those which might otherwise be discarded without being used may be used.

The principal elements of the incineration ash from sewerage sludge to be used in the present embodiment include Si, Al, Fe, Ca, P, Mg, Na, K or the like, among which P, Ca, Na and K which easily forms a glass phase are contained therein in abundance such that sintering and reaction proceeds simultaneously at a relatively low temperature.

The forming binder to be used in the present invention includes one or a combination of, for example, clay, bentonite, organic pastes or the like and said forming binder facilitates a forming operation by means of a press or the like. Further, it is also possible to use sodium silicates, in which case carbon dioxide is blown for hardening.

The aggregate used in the present invention is required to be a highly fire-resistant inorganic material including one or a combination of sherd (wastes from tile materials, pottery or the like), building stone fragments, silica sand, fly ash, chamotte, mica, slag or the like.

Further, although building material wastes containing asbestos and incineration ash from sewerage sludge are regarded as acting as a fusion binder, the more such sintered mixtures is contained, the more it is required that the sintering temperature for producing porous ceramics is the higher, thus forcing the fuel expenses to rise. However, addition of a fusing agent makes it possible for the sintering operation to be conducted at a lower temperature.

The fusing agent used in the present invention includes on or combination of frit, glaze sludge, glass wastes or the like.

In order to sinter the above mixture, the temperature is required to be 600° C. or more where it is confirmed by an X-ray analysis that no asbestos peak is observed.

Although there is no limitation to the time required for the sintering operation, it is in order if there is sufficient time until it is confirmed by an X-ray diffraction that there remains no asbestos contained in the building material wastes after the sintering at said sintering temperature such that the binder fully works on the aggregate. Such time is determined on the basis of the ingredients of a fusing binder, their particle sizes, and the sizes of formed products, conditions in the kiln including for example a tunnel kiln and roller house kiln.

As compared to the case where building material wastes containing asbestos are provisionally sintered before the said wastes are mixed with incineration ash from sewerage sludge and aggregates, shrinkage percentage is greater in case where the mixing and sintering are done without such provisional sintering. This is done for the need for greater porosity, which improves property as a porous material.

As a method of decorating such porous ceramics, it is offered a practice of adding a glaze or pigments at the time of mixing before sintering. It is also in order that the product is glazed and further sintered after the sintering Otherwise, there is a method of integrating said porous ceramics to such porous ceramics which has been provided with a decorative layer.

Hereinafter, a concrete explanation will be given to the embodiment but the invention is not limited thereto.

### EXAMPLE 4

TABLE 8 shows a principal composition of the substrate of the so-called asbestos slate roof material which is a building material waste containing asbestos. Said substrate was crushed into fragments having a size of 10 mm or less by a jaw crasher, which were put into a bowl mill where the substrate fragments were pulverized with water added for about 5 hours to obtain a slurry. The thus obtained slurry was dried to obtain a dried powder. TABLE 9 shows the ratio of composition of the used incineration ash of sewerage sludge. As a fusing agent, Ferro's “MX-3P” was used while, as a binder, clay (dried and able to pass through 80 mesh), for an aggregate, sherd (7 to 20 mesh) was used. Mixing was conducted with the mixing ratio of TABLE 10 with water being added as necessary for kneading and forming particles. The resultant mixture was formed into a flat plate (50 g/piece) by a press before the flat plate was sintered at a temperature of 1050° C. for one hour in the electric furnace. The physical property of the resultant plate material is as shown in TABLE 11 to indicate that the same is an excellent example of a porous ceramic as a permeable block. Said sintered product was confirmed by an X-ray diffraction as having no asbestos peak.

TABLE 8

| Composition of Substrate of Asbestos | |
|---|---|
| Slate Roof Material | Weight % |
| Asbestos | 20 |
| Cement | 39 |
| Mircro Silica Sand | 26 |
| Reduced Scrap | 15 |
| Total | 100 |

TABLE 9

| Chemical Composition of Incineration Ash of | |
|---|---|
| Sewerage Sludge | Weight % |
| SiO₂ | 42 |
| Al₂O₃ | 18 |
| Fe₂O₃ | 11 |
| CaO | 6 |
| MgO | 2 |
| Na₂O | 1 |
| K₂O | 2 |
| P₂O₅ | 15 |
| Rest | 5 |
| TOTAL | 100 |

TABLE 10

| Material | Mixing Ratio(Weight %) |
|---|---|
| Dried Powder of Asbestos | 18.9 |
| Slate Roof Material | |
| Incineration Ash from | 10.5 |
| Sewerage Sludge | |
| MX-3P | 12.6 |
| Clay | 6.0 |
| Sherd | 52.0 |

TABLE 11

| Item | Measured Value | Assessment |
|---|---|---|
| Shrinkage (%) | 4.03 | Good |
| Bulk Specific Weight | 1.55 | Good |
| Permeable Time | 3.5 | Good |
| Bending Strength (N/cm²) | 560 | Good |

With this embodiment, the sintered product can be used as a porous ceramics which is made asbestos-free and has a high recycling efficiency. Although there is a problem therewith that it is required to have a high sintering temperature with a higher mixing ration of asbestos containing building material wastes, sintering can be done at a lower temperature by adding a fusing agent, thus reducing the fuel cost.

Although there are various methods for sintering, it is advisable that asbestos containing material wastes are, if possible, piled up to be sintered in a tunnel kiln in stead of crushing. Otherwise, the wastes may be fed into the kiln one by one where to be sintered. In view of fuel costs, however, it is advisable that the wastes are to be crushed into a size to some extent.

The time required to sintering is not limited to a particular length. All needed is that the asbestos contained in building material wastes are rendered non-hazardous at the above mentioned temperature; that is, the there is no asbestos peak observed by an X-ray diffraction. Therefore, such time is decided on the basis of the size of the building material wastes and the ways in which the building material wastes are piled up.

The primary ingredients contained in an incineration ash from the sewerage sludge to be used as a fusion binder include Si, Al, Fe, Ca, P, Mg, Na, K among which P, Ca, Na and K which can easily forms a glass phase are contained in abundance such that the sintering reaction proceeds simultaneously at a relatively low temperature.

A binder for molding used in the present invention includes one or combination of clay, bentonite, organic pastes or the like, which easily helps a primary molding by means of a press or the like.

Further, a sodium silicate may be used where carbon dioxide is blown to harden the same.

The aggregate used in the present invention is a highly fire resistant inorganic material including one or combination of sherd, type wastes, pottery wastes, building stone fragments, silica sand, fly ash, chamotte, chip, slag or the like.

Further, if more building material wastes which act as a fusion binder but contain asbestos are mixed in the manufacture of non-hazardous sintered products, a higher sintering temperature is needed such that the cost for fuel invariably increases. However, a lower sintering temperature is possible by adding a fusing agent.

The fusing agent to be used in the present invention includes one of frit, glaze sludge, glass wastes or a combination thereof.

TABLE 12 shows test data concerning the rate of mixture of the non-hazardous sintered product and a fusing agent such as Ferro's “MX-3P” together with the physical properties of the respective ingredients. The sintering was done at a temperature of 1050° C. In order to fuse the aggregate to stick firmly to each other, it is necessary for the binder to be softened and fused at a sintering temperature range, where it is assumed that the shrinkage percentage, the bulk specific gravity and the bending strength are at maximum levels thereof while the water absorption percentage is nil. If the softening and fusion process further proceeds, the binder comes to have excessive foams therewithin to accelerate the expansion and transformation thereof.

TABLE 12

| | | | |
|---|---|---|---|
| Ratio of Mixture | Non-hazardous | 90 | 60 |
| (Weight %) | asbestos-free | | |
| | sintering product | | |
| | MX-3P | 10 | 40 |
| Rate of Shrinkage (%) | | 1.83 | 12.13 |
| Bulk Specific Gravity | | 1.64 | 2.26 |
| Water Absorption Percentage (%) | | 27.04 | 0.07 |
| Bending Strength (N/cm²) | | 1200 | 5420 |

As shown in Table 12, it is shown that the more the fusing agent is used upon the sintered product, the more the softening and fusion accelerated.

As a method of decorating the permeable blocks, some method includes sintering with a glaze or pigments at the time of mixture and/or further sintering with a glaze thereafter.

Hereinafter, a further explanation will be given by showing another example but the invention is not limited thereto.

### EXAMPLE 5

The asbestos containing building material wastes Colonial: the principal ingredients are as shown in TABLE 13) are subjected to a temperature of 1000° C. for 15 minutes. Thereafter, the wastes were passed through a punching metal with a punched hole having a diameter of 2 mm. In this connection, it was confirmed by an X ray diffraction that this sintered product shows no asbestos peak. The ratio of incineration ash of the used sewerage sludge is shown in TABLE 13, where Ferro's “MX-3P” is used for a fusing agent while clay (dried product passable through 80 mesh) is used for a molding binder and sherd (7 to 20 mesh) is used for an aggregate. The mixture is in the mixing ratio as shown in TABLE 14 where an appropriate amount of water is added for kneading and forming the same into particle form before formed into a plate (50 g/piece) by a hand press for being sintered at a temperature of 1050° C. for in an electric kiln. The physical properties of the obtained plate material are as shown in TABLE 16 which shows that the product is an excellent permeable block.

TABLE 13

| Material for Asbestos | |
|---|---|
| Slate Roof Material | Part by Weight |
| Asbestos | 20 |
| Cement | 39 |
| Micro Silica Sand | 26 |
| Reduced Scrap | 15 |
| TOTAL | 100 |

TABLE 14

| Chemical Composition | |
|---|---|
| of Incineration | |
| Ash from Sewerage Sludge | Part by Weight |
| SiO₂ | 40 |
| Al₂O₃ | 17 |
| Fe₂O₃ | 10 |
| CaO | 7 |
| MgO | 3 |
| Na₂O | 1 |
| K₂O | 2 |
| P₂O₅ | 15 |
| Rest | 5 |
| Total | 100 |

TABLE 15

| | Rate of Mixture |
|---|---|
| Raw Material | (Weight %) |
| Asbestos-free Sintered Product | 12.6 |
| Incineration Ash from Sewerage Sludge | 21.0 |
| MX-3P | 8.4 |
| Clay | 6.0 |
| Sherd | 52.0 |

TABLE 16

| Test Item | Measured Value | Assessment |
|---|---|---|
| Shrinkage (%) | 2.43 | Good |
| Bulk Specific Gravity | 1.54 | Good |
| Permeation Time | 4.9 | Good |
| Bending Strength | 560 | Good |

According to the method in this embodiment of the invention, the sintered product can be used as a porous ceramics which is made asbestos-free and has a high recycling efficiency. Although there is a problem therewith that it is required to have a high sintering temperature with a higher mixing ratio of asbestos containing building material wastes, a lower sintering temperature is possible by adding a fusing agent, thus reducing the fuel cost.

A further embodiment will be explained hereinafter. Basically, the procedures and steps which are to be taken are similar to the previous embodiment.

As pointed out in the previous embodiment, the time required to sintering is not limited to a particular length. All needed is that the asbestos contained in building material wastes are rendered non-hazardous at the above mentioned temperature; that is, the there is no asbestos peak observed by an X-ray diffraction. Therefore, such time is decided on the basis of the size of the building material wastes and the ways in which the building material wastes are piled up. However, it is to be noted that as a means of sintering, the tunnel kiln or roller house kiln is preferred.

It is further to be noted that as compared to the case where building material wastes containing asbestos are provisionally sintered before the said wastes are mixed with incineration ash from sewerage sludge and aggregates, the shrinkage percentage is greater in case where the mixing and sintering are done without such provisional sintering. This is done for the need for the greater porosity, which improves property as a porous material.

As a method of decorating such porous ceramics, it is offered a practice of adding a glaze or pigments at the time of mixing before sintering. After the sintering, the product is glazed and further sintered. Otherwise, there is a method of integrating said porous ceramics to such porous ceramics which has been provided with a decorative layer.

Hereinafter, this embodiment will be explained in more detail but the invention is not to be limited to this embodiment.

### EXAMPLE 6

The asbestos containing building material wastes (Colonial: the principal ingredients are as shown in TABLE 17) are crushed by means of a jaw crusher to a particle size of 10 mm or less and further crushed in a bowl mill for 5 hours while water is being added to obtain a slurry. The thus obtained slurry is dried to obtain a dried power. The ratio of composition of the used incineration ash from the sewerage sludge is shown in TABLE 18. Ferro's “MX-3P” is used for a fusing agent while clay (dried product passable through 80 mesh) is used for a molding binder and sherd (7 to 20 mesh) is used for an aggregate. The mixture was mixed in the mixing ratio as shown in TABLE 19 where an appropriate amount of water is added for kneading and forming the same into particle form before formed into a plate (50 g/piece) by a hand press for being sintered at a temperature of 1050° C. for in an electric kiln. The physical properties of the obtained plate material are as shown in TABLE 20 which shows that the product is an excellent permeable block.

Further, it was confirmed by an X-ray diffraction that no asbestos peak was shown.

TABLE 17

| Composition of Substrate of | |
|---|---|
| Asbestos Slate Roof Material | Weight % |
| Asbestos | 20 |
| Cement | 39 |
| Micro Silica Sand | 26 |
| Reduced Scrap | 15 |
| Total | 100 |

TABLE 18

| Chemical Composition of | |
|---|---|
| Incineration Ash of | |
| Sewage Sludge | Weight % |
| SiO₂ | 42 |
| Al₂O₃ | 18 |
| Fe₂O₃ | 11 |
| CaO | 6 |
| MgO | 2 |
| Na₂O | 1 |
| K₂O | 2 |
| P₂O₅ | 15 |
| Rest | 5 |
| TOTAL | 100 |

TABLE 19

| | Mixing |
|---|---|
| Material | Ratio(Weight %) |
| Dried Powder of | 18.9 |
| Asbestos Slate Roof | |
| Material | |
| Incineration Ash from | 10.5 |
| Sewerage Sludge | |
| MX-3P | 12.6 |
| Clay | 6.0 |
| Sherd | 52.0 |

TABLE 20

| Test Item | Measured Value | Assessment |
|---|---|---|
| Shrinkage (%) | 4.03 | Good |
| Bulk Specific Weight | 1.55 | Good |
| Permeation Time | 3.5 | Good |
| Bending Strength (N/cm₂) | 560 | Good |

According to the present invention, wastes containing asbestos which is harmful to human health axe not only made non-hazardous but incineration ash from inorganic wastes including sewerage sludge, general wastes, civil engineering wastes, ceramic wastes or the like which have so far been used only for reclamation purposes may be mixed therewith to be subjected and reacted to the sintering step, thus obtaining non-hazardous sintered products for recycling. Further, sherd, glass wastes or the like may also be mixed therewith such that obtained sintering reaction products are provided in the form of non-hazardous permeable blocks such as porous ceramics having a high recycling efficiency. If asbestos contents are too high, a fusing agent may be added to suppress a inevitable rise of the sintering temperature such that fuel expenses can be reduced.

What is claimed is:

1. A non-hazardous asbestos-free sintered product obtained by sintering reaction of asbestos containing building material wastes comprising asbestos containing building material wastes; and inorganic wastes, said building material wastes and said inorganic wastes being crushed, mixed with each other, reacted and sintered at a temperature of 600° C. to 1500° C.

2. A water permeable block comprising aggregates; fusion binder; and molding binder, said fusion binder including a non-hazardous sintered product obtained from asbestos containing building material wastes and incineration ash from sewage sludge.

3. A water permeable block as set forth in claim 2, further including a fusing agent added thereto.

4. A porous ceramics principally comprising asbestos containing building material wastes; incineration ash from sewerage sludge; aggregates; and a molding binder.

5. A porous ceramics as set forth in claim 4, further including a fusing agent added thereto.

6. A method of producing a porous ceramics comprising the steps of sintering asbestos containing building material wastes; adding incineration ash from sewerage sludge to mix therewith and subjecting the mixture to sintering again.

7. A method of producing a porous ceramics comprising the step of sintering principally asbestos containing building material wastes and incineration ash from sewerage sludge.
